(19) United States
(12) Patent Application Publication
(10) Pub. No.: US 2018/0169589 A1
(43) Pub. Date: Jun. 21, 2018

(54) WATER TREATMENT SYSTEM AND METHOD

(71) Applicant: DMAC IP PTY LTD, Brisbane (AU)

(72) Inventor: David Campbell MACFARLANE, West End Brisbane (AU)

(21) Appl. No.: 15/736,932

(22) PCT Filed: Jun. 15, 2016
(86) PCT No.: PCT/AU2016/050489

§ 371 Date: Dec. 15, 2017

(30) Foreign Application Priority Data
Jun. 15, 2015 (AU) 2015902242

(51) Int. Cl. B01D 69/02; B01D 63/08; B01D 63/10; B01D 63/02; B01D 63/06; C02F 1/44; C02F 1/02; B01D 61/00; B01D 61/04; B01D 61/02

(52) U.S. Cl. CPC B01D 69/02; B01D 63/08; B01D 63/10; B01D 63/02; B01D 63/06; C02F 1/44; C02F 2103/08; B01D 61/002; B01D 61/04; B01D 61/02; C02F 1/441; C02F 1/445; C02F 1/02

(57) ABSTRACT

A water treatment system is provided that provides desalination of water for aquifer recharge, agricultural, mining or industrial use. The water treatment system comprises: an input, for receiving contaminated water to be treated; an output, for providing treated water, wherein a level contamination of a contaminant i s lower in the treated water than in the contaminated water; and a hydrophilic membrane between the input and the output. The hydrophilic membrane configured to allow water to pass from the input to the output, and to at least partly impede the passage of the contaminant from the input to the output. In use, a low pressure is applied to the output to cause the water to flow across the membrane.

### TECHNICAL FIELD

The present invention relates to treatment of water. In particular, although not exclusively, the invention relates to desalination of water for aquifer recharge, agricultural, mining or industrial use.

### BACKGROUND ART

Excessive salinity (the combination of all soluble cations and anions in a water body) can be a significant problem with water supplies destined for or associated with domestic use, agricultural and livestock production, and mining.

The salinity of a particular groundwater is a function of catchment hydrogeology, previous land management practices, natural rainfall and aquifer recharge, and patterns of groundwater extraction. Periods of drought reduce aquifer recharge and can lead to an increase in groundwater salinity. Australia has several groundwater basins, the most important of these being the Great Artesian Basin which covers 23% of the continent. For many areas of Australia, groundwater resources which can sustain commercial flow rates have a saline content that is unsuitable for certain types of irrigated crop systems, and other purposes.

Different crops, for example, have different salinity tolerance limits or thresholds. In agriculture the main soluble salts are comprised of cations calcium, sodium, magnesium, iron, aluminium, potassium and of anions carbonate, bicarbonate, chloride, phosphate, sulphate and silicate. If salinity exceeds these thresholds, then crop yield and crop quality is generally reduced. Certain high value crops, such as lettuce and beans, have low water salinity thresholds.

Furthermore, the mining of coal and other minerals and the production of coal seam gas is usually associated with waste waters of varying levels of salinity (including soluble commercial minerals) and contaminants, which must be managed in an environmentally friendly and safe manner. Currently the treatment of such saline water to meet environmental compliance conditions is costly.

Reverse osmosis is currently the predominant process used to desalinate waste water in the coal seam gas (CSG) and coal industry. Pressures of up to 800 pounds per square inch (psi) are applied against reverse osmosis membranes to force water across the membranes, leaving a high salinity waste liquid. A problem with reverse osmosis of the prior art is that the high pressures used require expensive, highly engineered systems and high (and thus expensive) energy inputs.

More recently, forward osmosis is being used in limited forms to desalinate water. In such case, a concentrated draw solution is used to induce a flow of water from a supply or feed through a suitable membrane driven by a difference in osmotic potential.

In short, prior art reverse osmosis and forward osmosis systems are generally costly, both in capital expenditure and operational expenditure and complex.

Accordingly, there is a need for an improved water management system and method.

It will be clearly understood that, if a prior art publication is referred to herein, this reference does not constitute an admission that the publication forms part of the common general knowledge in the art in Australia or in any other country.

### SUMMARY OF INVENTION

The present invention is directed to water treatment systems and methods, which may at least partially overcome at least one of the abovementioned disadvantages or provide the consumer with a useful or commercial choice.

With the foregoing in view, the present invention in one form, resides broadly in a water treating system comprising:

an input, for receiving contaminated water to be treated;

an output, for providing treated water, wherein a level contamination of a contaminant is lower in the treated water than in the contaminated water; and

a hydrophilic membrane between the input and the output, the hydrophilic membrane configured to allow water to pass from the input to the output, and to at least partly impede the passage of the contaminant from the input to the output;

wherein, in use, a low pressure is applied to the output to cause the water to flow across the membrane.

Preferably, the low pressure is vacuum driven. Preferably, the low pressure is below atmospheric pressure (1013 millibars (mbars) at sea level).

Preferably, the contaminant is one or more species of salt. The contaminated water may be mildly to highly salty water. Alternatively or additionally, the contaminant may be an organic contaminant, such as a hydrocarbon.

The system may include a vacuum pump, for applying the low pressure to the output. The vacuum pump is preferably of a type or configuration which is configured to handle the movement of water as a liquid not a vapour from the desalination unit, e.g. a liquid ring vacuum pump.

Preferably, the system further includes a waste output, for outputting concentrated contaminated water. Given the range of commercial applications envisaged, the concentrated contaminated water may have between twice and at least nine times the concentration of the contaminant than the input contaminated water.

Preferably the low pressure is between 913 mbar and 613 mbar. Suitably, the low pressure is between 10 kPa and 40 kPa below atmospheric pressure.

Preferably the low pressure is no lower than 113 mbar, or 90 kPa below atmospheric pressure. The input may be at or about atmospheric pressure.

The system may further include a filter (of one or more components) for filtering the contaminated water, wherein the filter is located between the inlet and the hydrophilic membrane. The filter may include membranes in the micro-ultra/nano pore size range, and/or activated carbon and/or ion-exchange filters for removing organic, silica or other contaminants which might be detrimental to the effectiveness of the hydrophilic membrane. In some cases the filter may comprise a sand filter.

The system may further include a heater for heating the contaminated water, wherein the heater is located between the input and the hydrophilic membrane. The heater may be an active heater or a passive heater. The heater is preferably a solar heater, and may operate directly using solar thermal energy, or indirectly through the use of a heat exchanger.

The heater may be configured to increase the temperature of the feed water by between 2° C. and 10° C. depending on season. The heater may be configured to increase the temperature of the feed water by at least 10° C. Alternatively, the heater may be configured to increase the temperature of the feed water by at least 20° C.

Alternatively, the heater may be configured to increase the temperature of the feed water by about 10° C. Alternatively again, the heater may be configured to increase the temperature of the feed water by about 20° C.

The system may comprise plurality of hydrophilic membrane assemblies between the input and the output. The hydrophilic membrane assemblies may include different types of hydrophilic membrane and/or be configured to provide cost-effective fit for purpose services over a wide range of saline water classes requiring target levels of desalination for specific purposes

A plurality of water treatment systems may be coupled in parallel, where, for example, all water treatment systems receive input contaminated water of the same salinity, or in series, where, for example, the output of one water treatment system feeds into the next water treatment system, leading to progressively more concentrated treatment waste.

The plurality of modules may be housed in a container, for example on a suitable compacted base or on a trailer.

The system may comprise an input chamber, for receiving the contaminated water to be treated and an output chamber, for receiving the treated water. The input chamber and output chamber may be separated by the hydrophilic membrane. The hydrophilic membrane may define at least a part of the input chamber and a part of the output chamber.

The hydrophilic membrane may comprise a flat sheet. The flat sheet may he supported in a suitable assembly that physically supports and protects the membrane in the vacuum range imposed and which is sealed so that no contaminated water can bypass into the permeate output chamber.

The system may include a plurality of input chambers, output chambers and hydrophilic membranes. The hydrophilic membranes may be parallel to each other. A waste output of a first module may be coupled to an inlet of a second module.

The system may comprise a hydrophilic membrane spirally wound around a lumen. The output may comprise an end of the lumen.

The hydrophilic membrane may comprise a tube or hollow fiber. The system may include a plurality of tubes or hollow fibers. The tubes or hollow fibers may be aligned any may be parallel with each other. The tubes or hollow fibers may be arranged in an elongate receptacle.

The tubes or hollow fibers may be between 200 and 2500 μm in diameter. Alternatively, the tubes may be about 25 mm in diameter.

The saline water feed systems may comprise a mine tailings damn, a coal mine saline water dam, an unused pit or a coal seam (CS) gas production waste water gathering system fed by bores producing CS gas and saline water or by one or more shallow or deep groundwater bores supporting diverse agriculture, livestock or forestry enterprises.

The system may be configured to supply treated water for irrigation. The system may be configured to supply treated water to an aquifer recharge system.

The treated water may be mixed with contaminated water to efficiently reduce an amount of contaminant in waste water or groundwater so that it can be used beneficially and in compliance of any relevant environmental regulatory conditions.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a water treatment system, according to an embodiment of the present invention;

FIG. 2 illustrates a schematic diagram of a serial water treatment system, according to an embodiment of the present invention;

FIG. 3a illustrates a mesh support, supporting a flat sheet membrane of the system of FIG. 2;

FIG. 3b illustrates a mesh support, supporting a flat sheet membrane of the system of FIG. 2;

FIG. 3c illustrates a first layer of the mesh support of FIG. 3b;

FIG. 3d illustrates a second layer of the mesh support of FIG. 3b;

FIG. 4 illustrates a schematic diagram of a spirally wound membrane water treatment module, according to a further embodiment of the present invention; and

FIG. 5 illustrates a schematic diagram of a hollow fibre water treatment module, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

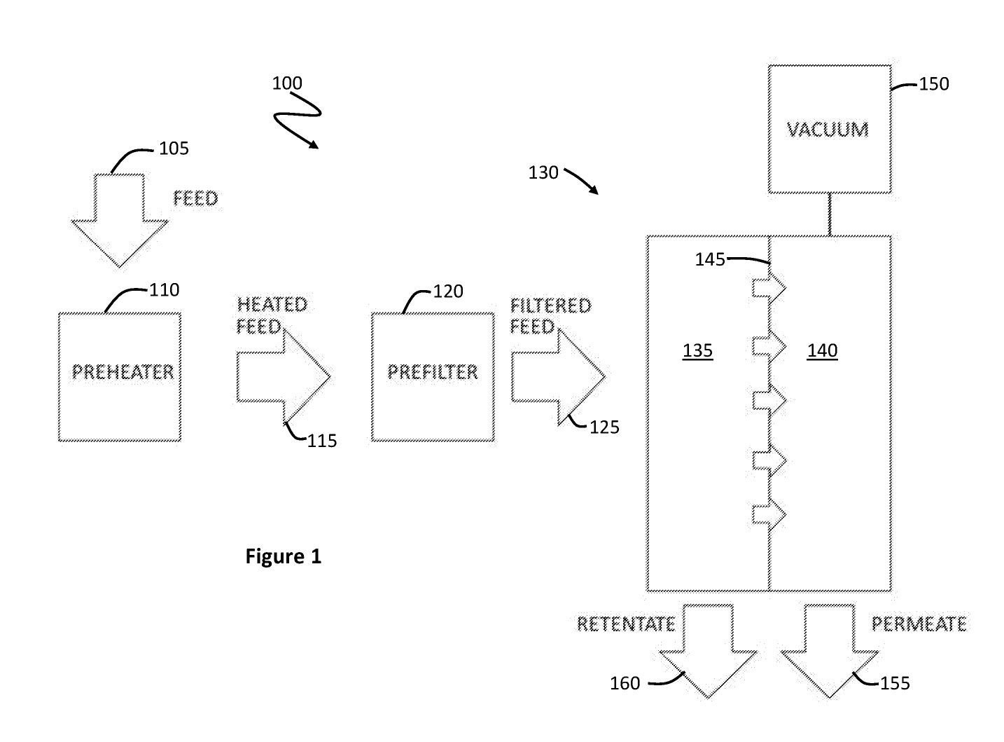

FIG. 1 illustrates a water treatment system 100, according to an embodiment of the present invention. The water treatment system 100 is particularly suited to desalination of water, but may also be used to remove other contaminants from water.

Advantageously, the system 100 enables the efficient treatment of water from mines, such as coal seam gas and coal mines, which generate large amounts of saline waste water. Similarly, the system 100 may be used in the broad agriculture sector to desalinate saline groundwater in particular as well as saline surface water, to enable the growth of salinity sensitive crops and to increase yields.

The system 100 is able to treat waste water in a cost efficient manner, and can thus be used to increase profitability and industry economic activity. In some situations, the system 100 may be able to treat water at a cost of 50% or less of that of prior art systems, such as reverse osmosis, forward osmosis or ion exchange based methods. The water treatment system 100 receives feed water 105 from a feed reservoir (not illustrated), which may, for example, be supplied from a mine or bore.

The feed water 105, which is typically at or near ambient temperature is preheated using preheater 110 in the form of a range of active/passive solar and/or heat exchange heating unit(s). The preheater 110 may be configured to increase the temperature of the feed water by 10° C., 20° C. or any suitable temperature. As discussed in further detail below, preheating of feed water entering the prefilter 120 improves efficiency of the system 100.

The heated feed water 115 is then prefiltered using a prefilter 120. Depending on the microbiological, turbidity or specific ionic content of the heated feed water 115, various types of filters may be utilised, including mechanical filters, sand filters, membrane or ion-exchange filters. Such prefiltering may reduce the operating costs of, or increase efficiency of, the system 100 or both.

After prefiltration, the heated, prefiltered feed 125 is then pumped into a separator 130 comprising a feed chamber 135, an output chamber 140, and a hydrophilic membrane separator 145 separating the feed chamber 135 from the output chamber 140. The hydrophilic separator 145 enables water to flow from the feed chamber 135 to the output chamber 140, but prevents salts and/or contaminants from flowing from the feed chamber 135 to the output chamber 140.

Periodically salts and/or contaminants that may become embedded in pores of the membrane 145. The system 100 may be backflushed to clean the membrane 145, as discussed in further detail below. Also input water may be introduced into the feed chamber 135 so that it moves rapidly across the membrane 145 providing a significant degree of self-cleaning/lateral mobilisation of salt particles that otherwise would potentially be able to block membrane pores.

The heated, then prefiltered feed 125 is pumped into the feed chamber 135. A vacuum pump 150 is then used to create a vacuum (i.e. low pressure) in the output chamber 140. The vacuum in the output chamber 140 draws water as a liquid through the hydrophilic membrane 145 into output chamber 140. Examples of suitable vacuums include at least 10 kPa or 100 mbars below atmospheric pressure, at least 40 kPa or 400 mbars below atmospheric pressure, and at least 60 kPa or 600 millibars below atmospheric pressure, or about 90 kPa or 900 mbars, 60 kPa or 600 mbars and about 40 kPA or 400 mbars above absolute vacuum. The input is generally at or near atmospheric pressure, which is typically 101.3 kPa (at sea level).

As salts are unable to pass the hydrophilic separator 145, a brine having a high concentration of salt remains in the feed chamber 135, which is removed from the feed chamber 135 once a target salinity is reached, for further processing as retentate 160. Such processing could include a renewable energy driven evaporation to crystalline salt process. Desalinated water (i.e. water with minimal residual salinity) is similarly removed from the output chamber 140 as permeate 155.

The passage of preheated, prefiltered feed 125 improves the efficiency of the hydrophilic separator 145 in that less energy is required to separate the pure (or near pure) water from the highly concentrated salts and the likelihood of performance reducing fouling of membrane surfaces and interstices is reduced. However, the skilled addressee will readily appreciate that where feed water temperatures are unusually high and/or where feed waters have negligible contamination, steps 110 and/or 120 may not be required in certain environments.

The vacuum pump 150 may comprise a liquid ring or screw pump, or other vacuum pump configuration specifically designed to transfer water as opposed to vapours or gases.

Appropriate hydrophilic membrane materials may be used for the hydrophilic separator 145 including commercially available forward osmosis membranes. Similarly, as discussed in further detail below, the hydrophilic separator 115 may, for example, comprise a flat sheet, a spirally wound, or a tubular or hollow fiber type configuration.

According to certain embodiments, the preheater 110 is a solar preheater which take the form of banks of 100 m to 400 m lengths of thin polyethylene tube between the feed reservoir and prefilter 120. Alternatively, a range of solar energy collectors may directly heat the feed directly or through circulating reservoir water through solar heat sinks and/or heat exchange units. The preheater 110 may utilise wind power, thermal energy, the combustion of fossil fuels, or be electrically powered.

Similarly, the vacuum 150 and/or prefilter 120 may be solar and/or wind powered with appropriate storage battery capacity. Alternatively, the vacuum 150 and/or prefilter 120 may be electrically powered or powered by fossil fuels.

In the case that solar or wind energy is used by the system 100, backup generators may be provided for cases when insufficient solar and/or or wind energy is available, for example if it is continuously wet or windless conditions. The system 100 is advantageously configured such that solar energy collection capacity, together with appropriate energy storage, is sufficient to power the system 100 continuously (i.e. day and night) in Bureau of Meterorology 75 percentile cloud conditions.

The system 100 may include additional elements from treatment of the permeate 155, such as a de-oxygenation and chemistry balancing module in the case managed aquifer recharge, or chemical treatment modules for treating the retentate 160 or enhanced evaporation treatments of the retentate 160. In some situations, these additional water treatment elements may be required to satisfy regulatory guidelines and conditions.

A variety of brine management processes can then be used in relation to the retentate 160, which is generally moderately to highly saline. In particular, a concentration and crystallisation process may be used to further reduce the retentate 160 prior to transport or short or long-term storage. Generally processes of brine management and storage would be subject to regulatory guidelines and conditions.

Long term brine treatment and storage facilities would be situated above flood height, for environmental reasons, and this thus may require the pumping or transport of the retentate 160 from the system 100 to a suitable location. As described previously system 100 would be readily movable in the event of flood.

According to certain embodiments, the hydrophilic separator 145 is cleaned/descaled using chemical descalants that are circulated through the system 100, or by the reverse pumping of treated water (e.g. the permeate or water from another source) through the hydrophilic separator 145. Alternatively, the system 100 may be opened and cross-flow high pressure water may be used to clean to the hydrophilic separator 145 periodically.

According to certain embodiments, cleaning/descaling is performed periodically and automatically. In such case, chemicals may, for example, be stored in receptacles of the system 100 and automatically applied to at least the hydrophilic separator 145 at certain predefined intervals.

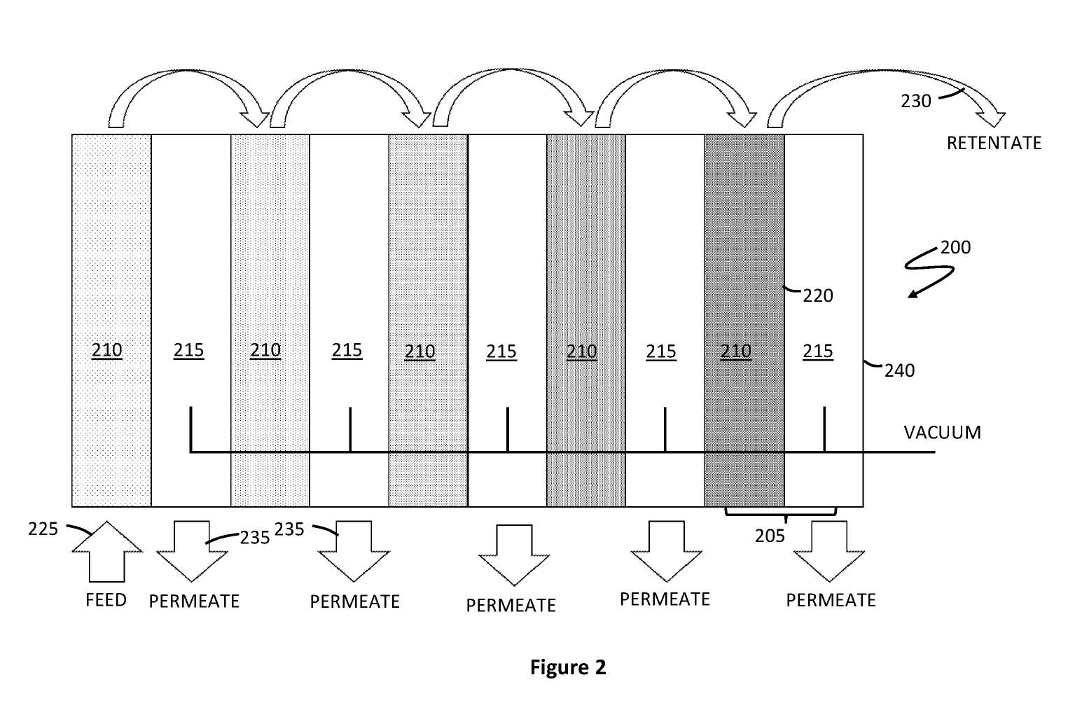

FIG. 2 illustrates a schematic diagram of a water treatment system 200, according to an embodiment of the present invention. The water treatment system 200 is similar to the water treatment system 100 of FIG. 1, but comprises a plurality of feed and output chambers, wherein the output chambers are serially coupled.

In particular, the system 200 comprises a plurality of separators 205, each comprising a feed chamber 210, an output chamber 215, and a hydrophilic membrane 220 separating the feed chamber 210 and the output chamber 215.

Each of the output chambers 215 is coupled to a vacuum source (not illustrated), as described above, which causes clean water to flow across the hydrophilic membrane 220 from the feed chambers 210 to the output chambers 215.

In use, feed 225 is provided into a first feed chamber 210, and vacuum is applied to the plurality of output chambers 215. This causes water to cross the hydrophilic membrane 220, resulting in a more concentrated solution in the first feed chamber 210. The concentrated feed is then passed to a second feed chamber 210, and so on, until ultimately being retrieved from the system 200 as a concentrated retentate 230. Simultaneously, as retentate is serially treated, reducing levels of treated water (permeate) are retrieved from the plurality of output chambers 215.

The system 200 is configured to continually receive flow, and continuously provide an output of clean water (permeate) and retentate. The clean water may be directed to irrigation, agro-industrial or aquifer recharge systems, and the retentate may be directed to further brine concentration systems, or storage.

The system 200 is about 1 m long, 0.6-0.8 m wide and 0.5 m high. Walls 240 of the system 200 form a suitably strong HDPE housing with a sealed and vacuum secure lid (not shown). The feed chambers 210 and output chambers 215 are placed along the length of the housing, such that each feed chamber 210 and output chamber 215 is about 10 cm wide. The membranes 220 and separators forming the feed chambers 210 and output chambers 215 may be welded or glued into the housing.

A plurality of the systems 200 may be coupled in parallel and housed on 6 m to 12 m containers. These containers could then be mounted on suitable pads or on trailers. This is particularly advantageous in agricultural environments situated on flood plains, where any equipment adjacent needs to be rapidly movable in the event of imminent flood. Managed aquifer recharge systems, on the other hand, may be situated above flood risk levels.

Pre-treatment systems, described above, may also be housed in similar transportable containers, to allow for their transportation as required.

According to an alternative embodiment, the separators 205 of the system 200 are coupled in parallel. In such case, an inlet manifold may distribute feed 225 to the plurality of feed chambers 210, rather than each feed chamber 210 feeding the next chamber 210.

According to certain embodiments, the membrane 220 is supported by an aluminium support, which internally supports the membrane and prevents the membrane from deforming from the vacuum applied to the output chambers 215. As an illustrative example, −40 kPa applied to a membrane of 0.5 m² size generates 2 tonnes of force on the membrane, which could force a non-supported membrane to flex substantially.

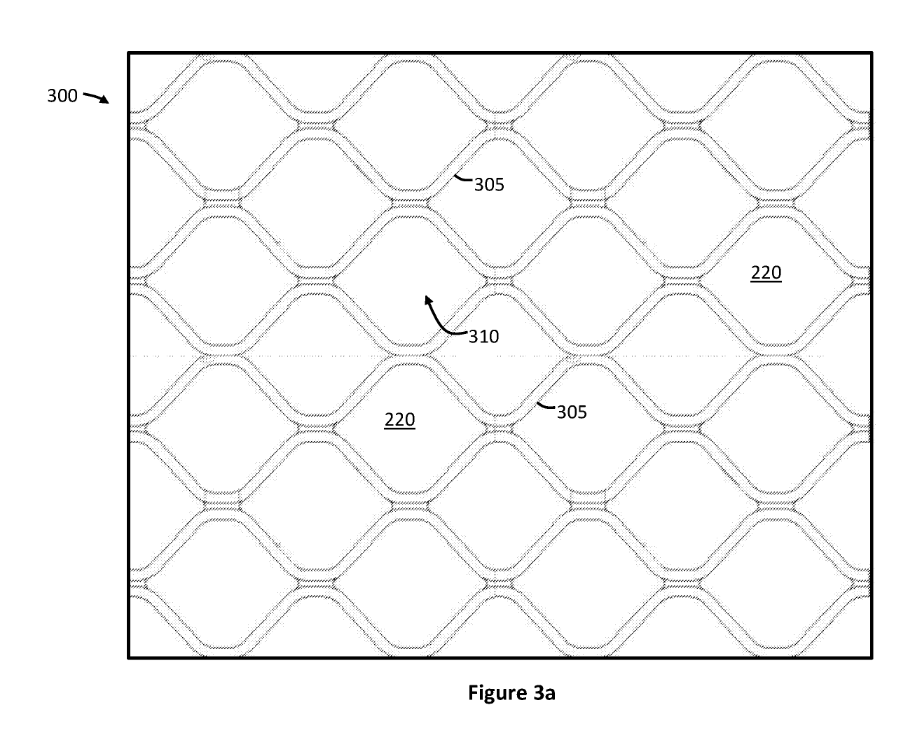

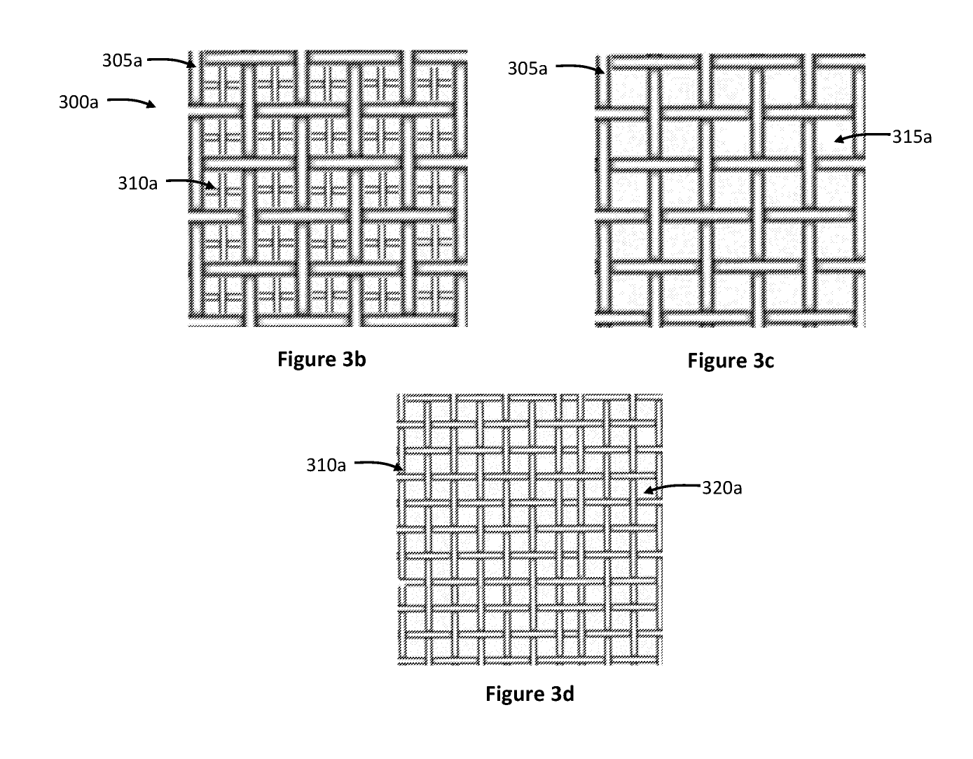

FIG. 3a illustrates a support 300, supporting the membrane 220 of the system 200. The support 300 is illustrated from the perspective of the output chamber 215.

The support 300 comprises elongate aluminium support members 305 arranged to form a plurality of apertures 310 of about 1 cm in diameter, through which the membrane 220 is exposed. As vacuum is applied to the output chamber 215, the support prevents the membrane from collapsing inwards towards the output chamber 215.

In other embodiments, the support 300 may be formed of woven or pressed aluminium, stainless steel, carbon fiber, or any other suitable material. In particular, apertures may be pressed in a sheet, or a plurality of fibers may be woven such that apertures are defined between adjacent fibers.

FIG. 3b illustrates a support 300a, supporting the membrane 220 of the system 200, according to an alternative embodiment of the present invention. The support 300a comprises a first support layer 305a, and a second support layer 310a. FIG. 3c illustrates the first support layer 305, and FIG. 3d illustrates the second support layer 310.

As best illustrated in FIG. 3c, the first layer 305a of the support comprises a woven mesh forming apertures 315a that are about 4 mm wide. As best illustrated in FIG. 3d, the second layer 310a of the support 300a comprises a woven mesh forming apertures 320a that are about 2 mm wide.

The mesh of the first layer 300b is much thicker than the mesh of the second layer 300c, and as such, the first layer 305a supports the second layer 310a, particularly when significant vacuum is provided to the membrane 220.

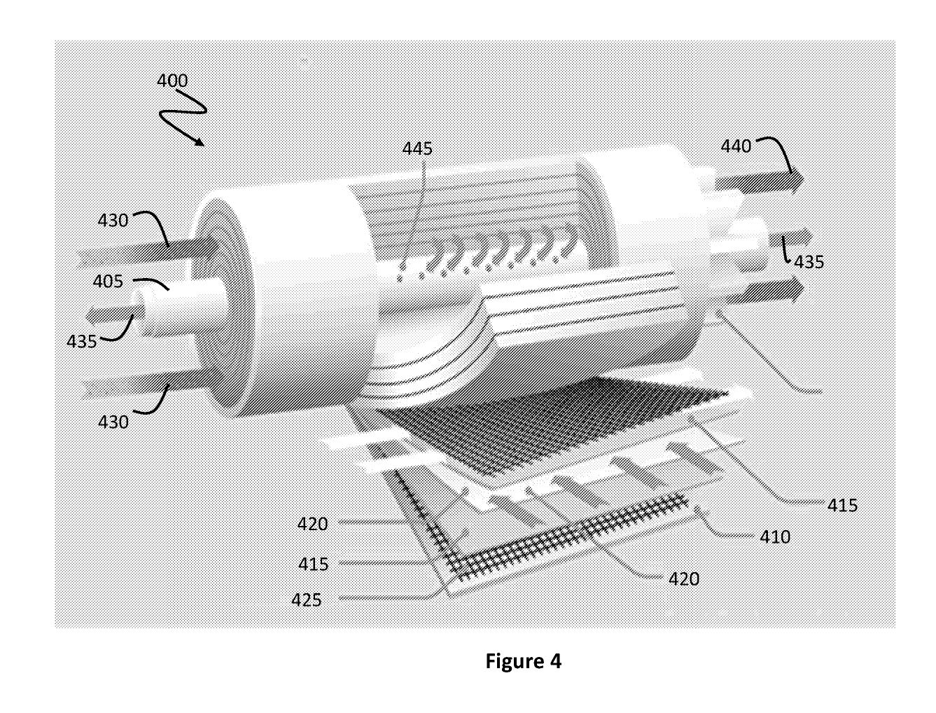

FIG. 4 illustrates a schematic diagram of a water treatment module 400, according to a further embodiment of the present invention. The water treatment system 400 is similar to the water treatment system 200 of FIG. 2, but comprises spirally wound membranes.

In particular, a plurality of membrane layers are wound around a porous lumen 405. The membrane layers comprise a cover 410, a hydrophilic membrane 415, and a permeate collection material 420. Furthermore, a spacer 425 is also placed between the cover 410 and the membrane 415 to define a feed channel that extends along a length of the water treatment module 400. The spacer 425 prevents the water treatment module 400 from collapsing onto itself during use.

In use, vacuum is applied to an interior of the lumen 405, which transfers suction to the permeate collection material 420, and feed 430 is provided into the feed channel. The vacuum causes a tangential flow of clean water across the hydrophilic membrane 415, and down the permeate collection material 420 to the lumen 405. A suction of up to −70 kPa (−700 mbar) is generally applied to the lumen 405, often between about −50 kPa (−500 mbar) and about −70 kPa (−700 mbar).

Permeate 435 (i.e. clean water) can then be retrieved from the lumen 405, and retenate 440 exits under gravity or under reduced vacuum from an end of the feed channel.

The lumen 405 comprises a plurality of apertures 445, which enable the permeate 435 to enter the lumen 405. However, the skilled addressee will readily appreciate that a porous material that does not have clearly defined apertures may instead be used.

The water treatment modules 400 are generally about 1 m long and 100 or 200 mm in diameter. Such size enables the use of forward osmosis as well as low energy, moderate salt rejection hydrophilic reverse osmosis membranes.

A plurality of modules 400 may be arranged in parallel, and fed with feed 430 by a manifold coupled to a reservoir holding pre-filtered and/or pre-heated feed. Similarly, a vacuum source can be applied to the lumens 405 of the modules 400 by a manifold, enabling a single vacuum source to be used.

The plurality of modules 400 may be placed in containers, as discussed above in the context of the system 200. Additionally, similar cleaning/anti-fouling methods may be applied to the modules 300 as those described above in the context of the system 200.

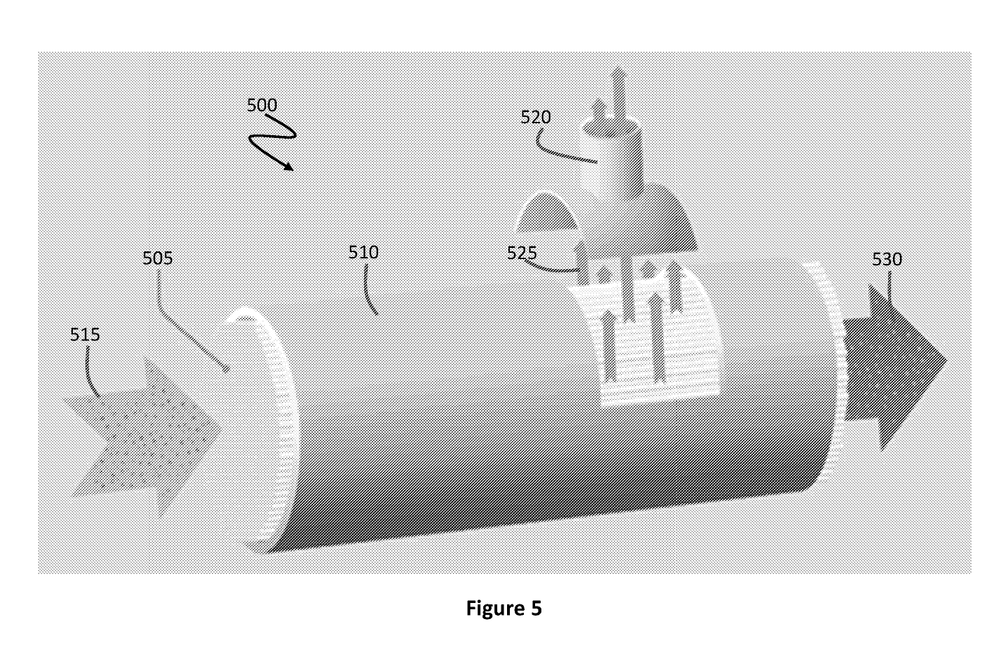

FIG. 5 illustrates a schematic diagram of a water treatment module 500, according to an embodiment of the present invention.

The module 500 includes a plurality of self-supporting fibers 505, arranged in parallel in an elongate receptacle 510. Each fiber 505 is hollow and comprises a hydrophilic outer skin which functions in a similar manner to the hydrophilic membranes discussed above. Each fiber 505 is typically between 200 and 2500 μm in diameter, and the relatively large number of hollow fibers 505 results in a very large surface area within the receptacle 510, increasing the efficiency of the separation process.

In use, feed 515 is provided in ends of the fibers 505, and vacuum is applied to an outlet 520 of the receptacle 510. The vacuum causes water (permeate) 525 to flow across the outer skin of the fibers 505, and out through the outlet 520, while retentate exits at ends of the fibers under gravity or low vacuum. This is referred to as an “inside-out” configuration.

The hollow fibers 505 may be blocked, or partially blocked, at one end, to prevent the contaminated water from flowing through the tubes too quickly.

The module 500 is generally about 1 m long and 100 mm or 200 mm in diameter, and may be housed and mobilised in a similar manner to the previously described modules and systems. Similarly, a plurality of modules 500 may be coupled in series or parallel.

According to alternative embodiments, the fibers 505 may comprise tubes approximately 25 mm in diameter. Such embodiments may be particularly suitable to mining waste water, or biosolids waste water environments.

The systems described above can be used to treat water for any purpose, but are particularly suited to desalinate water for irrigation or recharging aquifer under regulated management.

While the above systems and modules are generally described in relation to the flow of water across the membrane in one direction, it is possible to reverse the direction of flow while maintaining the same basic structure for specific applications.

According to certain embodiments, only a portion of the feed is treated, and treated feed is mixed with untreated feed to provide a suitable dilution. For example, in the case of irrigation, it may be desirable to halve the saline content of water from a bore. In such case, half of the water may be treated and mixed with half untreated water.

According to certain embodiments, the feed may comprise up to about 15000-45000 mg/L. Total Dissolved Solids (TDS) and the retentate may comprise up to about 250000-400000 mg/L TDS. The retentate may then he provided to a) a saline brine management or b) a thermal distillation processes, to produce a dry, crystalline brine salt waste/resource.

Advantageously, the above described systems provide a low cost, environmentally compliant water treatment solution that is particularly suitable for irrigation and managed aquifer recharge. By using vacuum as opposed to hydraulic pressure or osmotic potential differences across hydrophilic membranes, less energy is required, and the systems are simpler as very high pressures or draw solutions and the extraction of good quality water from draw solutions are not required.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A water treatment system comprising:
an input, for receiving contaminated water to be treated;
an output, for providing treated water, wherein a level contamination of a contaminant is lower in the treated water than in the contaminated water;
a hydrophilic membrane between the input and the output, the hydrophilic membrane configured to allow water to pass from the input to the output, and to at least partly impede the passage of the contaminant from the input to the output; and
a pump, configured to apply a low pressure to the output to cause the water to flow across the membrane.

2. The system of claim 1, wherein the low pressure is below atmospheric pressure.

3. The system of claim 2, wherein the low pressure is between 913 mbar and 613 mbar.

4. The system of claim 2, wherein the low pressure is no lower than 113 mbar.

5. The system of claim 1, wherein the input is at or about atmospheric pressure.

6. The system of claim 1, wherein the contaminant is one or more species of salt, and wherein the contaminated water comprises mildly to highly salty water.

7. (canceled)

8. The system of claim 1, further comprising a vacuum pump, for applying the low pressure to the output.

9. The system of claim 1, further including a waste output, for outputting concentrated contaminated water, wherein the concentrated contaminated water has between twice and nine times the concentration of the contaminant compared with the input contaminated water.

10. (canceled)

11. The system of claim 1, further including a filter for filtering the contaminated water, wherein the filter is located between the input and the hydrophilic membrane.

12. The system of claim 1, further including a heater for heating the contaminated water, wherein the heater is located between the input and the hydrophilic membrane, and wherein the heater is configured to increase the temperature of the feed water by at least 10° C.

13. (canceled)

14. The system of claim 1, comprising a plurality of water treatment modules coupled in parallel.

15. The system of claim 1, comprising a plurality of water treatment modules coupled in series, wherein the output of one water treatment module feeds into the next water treatment module, leading to progressively more concentrated treatment waste.

16. The system of claim 14, wherein the plurality of modules are housed in a container.

17. The system of claim 1, comprising an input chamber, for receiving the contaminated water to be treated, and an output chamber, for receiving the treated water.

18. The system of claim 17, wherein the input chamber and the output chamber are separated by the hydrophilic membrane and the hydrophilic membrane defines at least a part of the input chamber and a part of the output chamber.

19. (canceled)

20. The system of claim 1, wherein the hydrophilic membrane comprises a flat sheet.

21. The system of claim 20, wherein the system includes a plurality of flat hydrophilic membranes that are parallel to each other.

22. The system of claim 1, wherein the hydrophilic membrane is spirally wound around a lumen, wherein the output comprises an end of the lumen.

23. The system of claim 1, wherein the hydrophilic membrane comprises a plurality of tubes or hollow fibers.

24. (canceled)

25. The system of claim 24, wherein the tubes or hollow fibers are aligned and are parallel with each other and wherein the tubes or hollow fibers are arranged in an elongate receptacle.

26. (canceled)

27. (canceled)
